(19) United States
(12) Patent Application Publication
(10) Pub. No.: US 2005/0080620 A1
(43) Pub. Date: Apr. 14, 2005

(54) DIGITIZATION OF WORK PROCESSES USING WEARABLE WIRELESS DEVICES CAPABLE OF VOCAL COMMAND RECOGNITION IN NOISY ENVIRONMENTS

(75) Inventors: Kotesh Kummamuri Rao, Pearland, TX (US); Michael Brynn House, Clifton Park, NY (US); Robert Martin Roney Jr., Schoharie, NY (US); Andrew Travaly, Ballston Spa, NY (US)

Correspondence Address: NIXON & VANDERHYE P.C./G.E., 1100 N. GLEBE RD., SUITE 800, ARLINGTON, VA, 22201, US

(73) Assignee: GENERAL ELECTRIC COMPANY, Schenectady, NY (US)

(21) Appl. No.: 10/605,582

(22) Filed: Oct. 9, 2003

(51) Int. Cl. G10L 21/00

(52) U.S. Cl. 704/226

(57) ABSTRACT

In an information processing system having an equipment controller for enabling the digitization of complex work processes conducted during testing and/or operation of machinery and equipment, a local wireless communications network is implemented using at least one fixed point wireless communications access station and one or more voice-responsive wireless mobile computing/communications devices that are capable of accurate vocal command recognition in noisy industrial environments. The computing/communications device determines spectral characteristics of ambient non-speech background noises and provides active noise cancellation through the use of a directional microphone and an adaptive noise tracking and subtraction process. The device is carried by a user and is responsive to one or more vocal utterances of the user for communicating data to the information processing system and/or generating operational control commands to provide to the equipment controller for controlling the machinery or equipment.

### BACKGROUND OF INVENTION

The present invention relates to data acquisition and control of machinery via a system and apparatus for digitization of work processes over wireless communications network using wearable computation/communication devices having vocal command recognition in noisy environments.

Acquisition of accurate and up-to-date information concerning the operational status, condition and ongoing performance of all equipment that plays a critical role in a particular industrial process or system such as, for example, the large electric motors used in industrial manufacturing processes or turbines used in commercial power generation and the like is crucial in assuring and maintaining a successful commercial operation. Consequently, considerable efforts have been expended to develop and improve upon the existing conventional methods and apparatus used for monitoring and maintaining the operation of such “critical” equipment. In this regard, robust methods of inspection and fault prediction are highly desirable for equipment used in commercial power generation systems, since whenever such equipment must be taken off-line for repair or maintenance its inoperability may adversely impact other revenue generating processes such as commercial production and manufacturing facilities.

In order to detect impending failures, robust procedures for equipment inspection or predictive maintenance usually involve the monitoring and inspection of a variety of equipment operational parameters over a period of time. Conventionally, one or more parameters of a critical piece of machinery or equipment are monitored over time and data is collected at predetermined intervals. A maintenance recommendation is then triggered whenever the value of a particular monitored parameter happens to be recognized as exceeding a predetermined threshold.

One contemporary technological trend is to automate such inspection and monitoring processes as much as possible by affixing sensors and transducers to critical equipment and continuously collecting and monitoring important operational parameters through a variety of on-line and off-line electronic data monitoring techniques. In this manner, parameter data for a system or process may be continually tracked and an alarm may be immediately triggered if threshold values for particular parameters are detected as being exceeded. However, some level of human intervention and interaction is almost always still required especially in the case of large or complex industrial systems such as, for example, land-based power generation systems.

At many land-based power generation plants, the compressor components of large gas turbines engines used in power generation must be operated at mechanically stressful high pressures to be efficient and, consequently, numerous tests are often performed on-site by a field maintenance engineer to ensure that such engine components are maintained in prime condition. Such tests typically rely on a variety of different instruments and the field maintenance engineer may first need to attach sensors at several different locations in/on the turbine to measure specific engine parameters. The measured parameter values are then recorded and compared by the field engineer to known acceptable values to determine whether the gas turbine should remain in operation.

If certain measured parameter values are determined to be outside of an acceptable range, the field engineer may need to communicate with a remotely located operations control engineer who is responsible for controlling the immediate operation of various components such as valves, pumps, switches, etc. of the turbine. As such, field testing procedures, inspections and even routine operational activities can quickly become very labor intensive, requiring multiple engineers to perform even the most simple tasks. Consequently, in order to provide a working line of communication between all involved personnel, radio and/or telephone communication links must be established and constantly maintained thus complicating and slowing down the overall inspection/testing process. In addition, access and communication with remote database and/or needed computational facilities can often be slow or non-achievable in real-time, thus adding further inefficiencies to ongoing inspection and predictive maintenance procedures.

In many commercial environments, conventional telephone line or cable connections are often used to establish corporate intranet connections or virtual private networks (VPN) for accessing various in-house computational facilities and resources. Unfortunately, at a remote point of service in the field, the loss of information that is often experienced with conventional telephone and cable line communications does not allow, for example, an immediate use of remote computational facilities and various utility software applications or archived data that may be stored on a remote server on the network. Often, test/inspection data that is obtained and stored at a testing site in the field must be up-loaded off-line to a remote server after completing the testing/inspection process. In addition, since many test and inspection procedures must be performed by several engineers who communicate contemporaneously, the large volumes of data often cause issues with the bandwidth limitations of conventional telephone and radio communications. Furthermore, installation costs and the time required for setting up the custom land-line communication links needed for such activities is often very high. Thus, there is a need to overcome the many communications problems and inefficiencies that are often encountered during the course of implementing robust test and inspection procedures, predictive maintenance and/or repair scheduling of “critical” industrial equipment and systems, especially with respect to equipment and machinery at power generation plants.

The problem with many of the inspections performed at power generation plants are due to the use of multiple pieces of test equipment and associated data entry tasks. Multiple inspectors are required to collect, analyze and record data from a single testing activity. More efficient means are required to reduce cost and the potential for human error. One proposed solution to at least some of the above problems may be provided through the use of a portable/wearable computer/data entry device operated by a field engineer that is coupled to a network of remote computational and data storage devices by using high bandwidth connectivity via a combination of satellite and/or high bandwidth landline connections and an on-site wireless local area network (LAN) system. Such an arrangement allows a digitization of work processes by a single person which typically may have required multiple personnel to complete. One example of such a system is provided in commonly assigned copending U.S. patent application Ser. No. 09/844,270, filed Apr. 30, 2001, entitled “DIGITIZATION OF WORK PROCESSES THROUGH THE USE OF A WIRELESS NETWORK WITH USER WEARABLE END DEVICES”, which is hereby incorporated by reference herein.

Unfortunately, the portable computer/data entry devices of the above mentioned system often require numerous and extensive manual command and data entry operations to acquire, analyze and manipulate data for complex work processes or, for example, to input multiple commands to conduct specific plant operations and testing procedures or to perform other types of communication tasks. Performing such manual entry operations can be both tedious and time consuming, as well as being prone to error. In addition, manual entry of commands and data detracts from a field engineer's attention and efficiency at the work site and results in reduced productivity and increased error. One solution to this problem, that would potentially increase a worker's productivity while minimizing data and communication entry errors, may be achieved through the implementation of conventional voice recognition/enabling technology. However, conventional voice recognition/enabling technologies are much too susceptible to errors induced due to the extensive background noise that occurs in a typical power plant environment. Consequently, a voice recognition/enabling technology which is operable in noisy environments and is implementable in a work process digitization system using portable/wearable computer/data entry type devices would be highly desirable.

### SUMMARY OF INVENTION

The present invention relates to a method and apparatus that enhances the productivity of field engineers through a combination of high-bandwidth wide area network (WAN) connectivity, on-site wireless local area network (LAN) systems, and wearable wireless computer devices having vocal command recognition and ambient noise suppression. (For the purpose of the present discussion, a “wearable” device encompasses computer and communications devices that are generally mobile and adapted to be carried or worn by a user.) In particular, through the use of a hands-free vocal-command recognition interface that can operate reliably in noisy industrial environments, the present invention enables a field engineer/inspector to remotely control and individually operate complex equipment and processes (e.g., gas turbine and generator equipment in a power generation plant) while also having the capacity to roam throughout the physical premises as opposed to being limited to the fixed location of an equipment control room. For example, using the present invention a field engineer may inspect, test and/or control various operations of complex machinery and processes from virtually any location in the plant.

The combination of using a hands-free vocal-command driven communication device and high bandwidth wireless connectivity with multiple people and computer network resources provides an enhanced degree of freedom and control in the performance of complex work processes by a single or few persons where, in the past, such work processes have required multiple personnel to complete. Using the present invention, a power plant field engineer may roam around or remain mobile at the location of specific equipment while performing multiple tasks, such as simultaneously controlling the operations of the equipment while acquiring parametric data, by simply vocalizing specific commands. In this manner, the present invention reduces or eliminates the inefficiency and inconvenience of having to relay information and commands to other operations control personnel stationed in a control room/station which is typically located some distance away from the actual equipment or processes being controlled. Moreover, the field engineer may use the present invention to leverage the expertise of a remotely located engineer/expert by providing that person with real-time data, video, and control connectivity in order to resolve a problem in a collaborative manner.

Unfortunately, the work environment of a typical electrical power generation plant has a variety of noisy equipment that may produce as much as 70-100 dB of baseline ambient background noise. This noise may be characterized as comprising both a “white” noise component created, for example, by operating turbines, and a “colored” (i.e., frequency-dependent) noise component contributed by related maintenance activities and the intermittent operation of various plant equipment such as cranes and welding machines. Voice recognition in such noisy environments requires continuous and nearly real-time mitigation of the ambient background noise. The present invention accomplishes this through the use of an adaptive noise signature recognition and canceling process implemented by the communication/computer device and a directional microphone for optimal reception of the speaker's voice. An integral ambient noise suppression process is provided for a voice-responsive computer-communication device for use in highly noisy industrial environments. This ambient noise suppression processing significantly improves real-time voice recognition of spoken commands despite the presence of a high degree of ambient background noise. In particular, the integral noise suppression process of the present invention may adaptively react in real time to various and changing ambient noises associated with different environments and effectively operates to eliminate such background noises when detected in an audio signal to improve voice recognition.

As presented in at least one example embodiment of the present invention disclosed herein, the wearable computer/communications device is programmed to implement an adaptive noise cancellation process that has a great robustness to changes in ambient non-speech background noise. This is accomplished at least in part by programming the device to detect the existence of predetermined noise signatures in the frequency domain of a pulse code modulated signal from a microphone associated with the wearable computer/communications device and subtracting those noise signal signatures from the microphone signal. Active filtering is also used to eliminate or significantly reduce both white and colored background noise. Once the non-speech ambient background noise is removed from the microphone signal, a conventional speech recognition technology, commercially available through Conversational Computing Corporation (Redmond, Wash.) as “Conversay™ Advanced Symbolic Speech Interface” (CASSI), is employed to provide speaker independent voice-recognition. For the example environment presented herein, a work process involves the need for controlling a gas turbine in a power generation plant while measuring turbine and generator parameters from a location at or near the turbine. The power plant control arrangement includes a primary computer/processor system comprising an equipment controller at a fixed location within the plant. This local processor system receives operational data from all critical machinery and equipment in the power plant. In the example system presented for providing digitization of work processes, the local processor system includes a land-line based local area network (LAN) that is provided with at least one wireless device LAN access interface station at a fixed location within the power plant. This LAN access interface station allows a mobile wireless computer/communications device which is carried by a field engineer to establish and maintain communication with the plant equipment controller on the LAN. The equipment controller is also capable of receiving commands from the voice-responsive wireless computer/communication device that is carried by the field engineer via the wireless communications interface/LAN access station to control the gas turbine.

In addition a fixed wireless communications access station or bridge antenna station having a transceiver system may be employed for transmitting and receiving signals from either the voice-responsive wireless computer/communication device or the wireless communications device LAN access station to a remote private network computer server or facilities which, for example, may in turn be communicatively coupled to the wireless access station to provide a wider area communication network arrangement. Such an arrangement may include another WAN/LAN, a satellite communications link, the public Internet backbone. The private server/computer facilities may include, for example, security firewall arrangements, additional computational equipment and/or a database for storing application data that is also all made accessible to the field engineer via the network communications arrangement.

A particularly beneficial aspect of the present system, is its ability to provide high bandwidth connectivity to a field engineer to enable, for example, the use of web-portal applications stored in a remote server at the point of service of the field engineer. Immediate access to web-portal applications is also made possible for a field engineer situated at an equipment installation site that does not otherwise have access to a landline telephone link via two-way satellite connectivity. A further beneficial aspect of the present system arrangement is that it allows a field engineer that is monitoring a piece of equipment at a first location share information with another person/engineer monitoring similar equipment at a different remote location such that the collaborative effort may be used to fine tune one piece of equipment based on parameters or settings of the equivalent equipment located at the other site.

### BRIEF DESCRIPTION OF DRAWINGS

The features of the invention believed to be novel are set forth with particularity in the appended claims. The invention itself, however, both as to organization and method of operation, together with further aspects and advantages thereof, may best be understood by reference to the detailed description taken in conjunction with the following drawings, in which:

FIG. 1 is a schematic diagram illustrating an example system for implementing the digitization of work processes using a wireless voice-responsive wearable computer/communication device; and

FIG. 2 is a high-level process flow diagram illustrating an example process implemented by a voice-responsive computer/communication device to provide adaptive ambient background noise cancellation for improved speech recognition in noisy environments.

### DETAILED DESCRIPTION

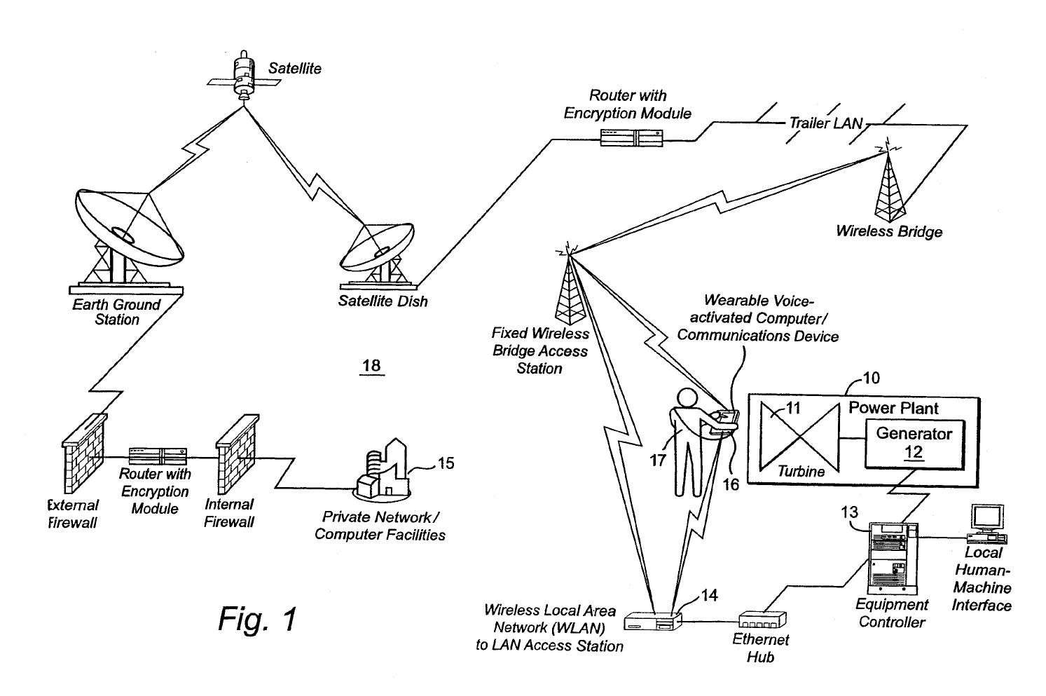

Referring first to FIG. 1, there is shown a schematic diagram illustrating an example system for implementing a digitization of work processes such as the inspection, testing and control of power plant machinery using one or more wireless voice-responsive wearable computer/communication devices. A conventional power plant, generally indicated at 10, typically includes at least a gas turbine engine 11, a generator 12 and possibly other machinery and equipment that may be considered as “critical” to the production of electrical power. In this example, the critical machinery and equipment in power plant 10 are fitted with sensors and operational parameter monitoring devices that are communicatively coupled either directly or via local wireless links to an on-site, or relatively local, processor and operations control system (Equipment Controller 13). Such a control system may also include a local human-machine interface (HMI) device for allowing a technician or engineer to operate and control the operations of the power plant.

A wearable wireless mobile computer/communication device 16 is carried around by a technician or engineer 17 while conducting tests or inspection tasks. Conventional application software such as, for example, Netmeeting™ available from Microsoft Corporation, may be used to communicate data between processor system 13 and wearable wireless mobile computer/communication device 16 carried around by a user 17. Wearable computer/communication device 16 comprises a conventional mobile computer type device that may be easily carried or worn by field personnel and used for data entry or display. Computer/communication device 16 also includes conventional means for implementing wireless communication of data (e.g., wireless LAN interfacing hardware). In addition, computer/communication device 16 is provided with appropriate hardware and software for implementing voice recognition and responding to vocalized commands. In particular, computer/communication device 16 is provided with an adaptive background noise suppression capability and a directional microphone which enable the device to perform accurate voice recognition even in very noisy industrial environments.

Operational parameter data from sensors on gas turbine 11 and/or generator 12 may be received by the processor system 13 either through direct electrical connection or via a conventional local wireless communications network or link. The processor system 13 may include a database system for storing operational data and forwarding the stored data to a wireless communications device interface such as, for example, fixed point wireless access station 14. Operational data received by the interface unit 14 is communicated to wearable computer/communication device 16 carried by a mobile user 17. The processor system 13 may include a controller for receiving instructions from field engineer/mobile user 17 carrying the wearable computer/communication device 16 to vary and control operational parameters of gas turbine 11 and/or generator 12.

The wearable computer/communication device 16 used by field engineer/mobile user 17 may also be communicatively linked to private network computer facilities 15 such as, for example, a corporate server system or the like, via a more extensive communications network generally indicated at 18. To ensure end-to-end security, all communications over the network may also be authenticated with a central server that employs a periodically rotating encryption key.

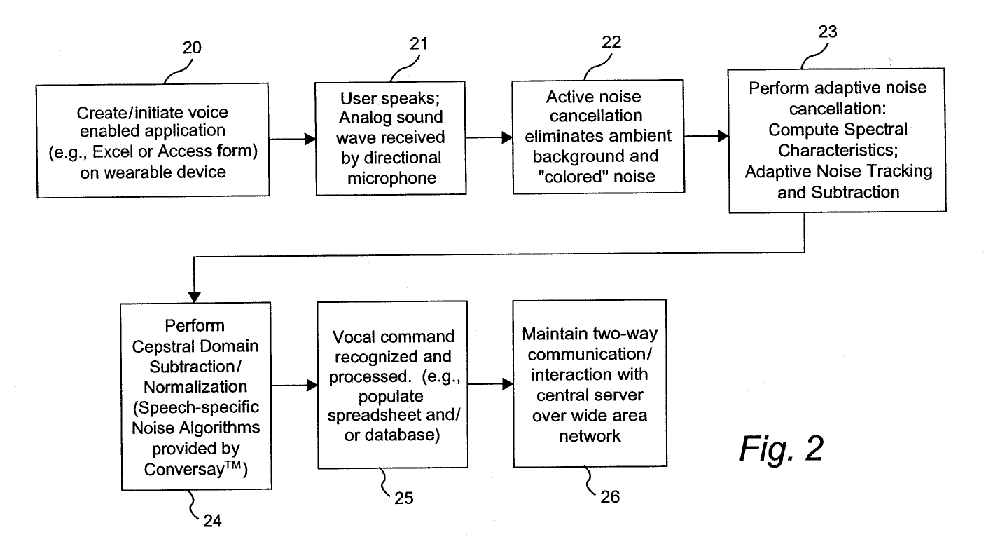

Referring now to FIG. 2, a high-level process flow diagram is illustrated which details an example process that may be implemented by a voice-responsive computer/communication device to provide both active noise reduction and adaptive ambient background noise cancellation for improved speech recognition in noisy environments. As indicated at block 20, a computer/communication device is configured to implement the improved noise cancellation process of the present invention when running a software application or conducting a process that requires the input of extraneous data or commands. Such a process may be a conventional piece of software such as Excel™ or Access™ or a spreadsheet application that requires the entering of data into a form, or it may be some other user specific software application that provides, for example, voiced commands/instructions to a remote machine controller for the purpose of remotely controlling the operation of a particular piece of equipment in real time. During use of the computer/communication device, and particularly whenever a user speaks and directs his/her voice toward the device, the analog sound waves of the user's voice are received by a directionally sensitive microphone connected to the computer /communication device, as indicated in block 21. Preferably, a high-quality microphone (not shown in the FIGURES) is used which has a specific directional field of operation outside of which the reception of sounds are diminished. The microphone may be integral or external to computer/communication device 16 and is positioned or oriented during use of the device so as to optimize reception of a user's voice and minimize reception of ambient sounds.

In a preferred example embodiment of the present invention, ambient background noise cancellation of sounds received by the microphone when a user speaks is performed in stages: First, an active elimination or reduction of ambient background noise is performed on the audio signal produced by the microphone in the analog domain using conventional analog filtering techniques. As indicated in block 22, this active noise cancellation reduces or eliminates certain predetermined “colored” (e.g., frequency band specific) background noises as well as ambient background noise generally. In addition, the receiver directionality properties of the directional microphone are capitalized upon when capturing the user's voice such directionality minimizes background noise and can improve the signal-to-noise ratio of the microphone signal by a factor of two or more. Next, the analog microphone signal is then sampled and pulse code-modulated. Adaptive noise cancellation is then performed in the digital domain, as indicated at block 23. In this stage, the digital pulse code modulated microphone signal is transformed into the frequency domain and predetermined ambient noises and/or noise bands are continually identified and subtracted according to their characteristic digital frequency domain signature. The computer/communication device may be readily programmed to identify one or more different noise signatures. The identification of such noise signatures domain may be based on known noise signatures and/or customized according to specific noise signatures at a particular location. In this manner, the background noise elimination process of the present invention is responsive to different types of background noise and is highly adaptive to any changes in the ambient background noise. This multi-stage noise elimination process provides improved recognition of voiced commands and/or spoken information directed toward the device during operation in noisy environments.

In a following stage, as indicated at block 24, speech-specific noise elimination is performed using conventional statistical noise cancellation processes such as Cepstral domain subtraction/normalization. For example, a commercially available software speech recognition engine, such as Conversay™ by Conversational Computing Corporation (Redmond, Wash.), may be used for providing both speech-specific noise elimination algorithms and performing speech recognition. In this manner the device is rendered capable of providing speaker-independent voice-recognition. Next, as indicated in block 25, the recognized commands and/or data are entered into the current application. During this process, as indicated in block 26, two-way interactive communication is maintained between mobile computer/communication device 16 and power plant processor system/equipment controller 13 (FIG. 1) and/or private network/computer facilities 15 via communications network 18.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A system for digitization of complex work processes conducted during operation and/or testing of machinery or equipment, comprising:
an information processing system including an equipment controller and at least one fixed point wireless communications access station, the information processing system receiving and processing data or commands from one or more wireless communications access station relating to said machinery or equipment, and the controller controlling operation of the machinery or equipment in response to data or commands from the information processing system; and
a voice-responsive computing/communications device, said device providing speech recognition and adaptively providing background noise suppression to reduce or substantially eliminate non-speech ambient background noise, wherein the voice-responsive/communications device is in wireless communication with the information processing system via at least one fixed point wireless communications access station and is responsive to one or more vocal utterances of a user for communicating data to the information processing system and/or generating operational control commands to provide to the equipment controller for controlling said machinery or equipment.

2. The system of claim 1 wherein said information processing system comprises a local area network (LAN).

3. The system of claim 1 wherein said voice-responsive computing/communications device includes a directional microphone.

4. The system of claim 1 further comprising a wireless communications network (WLAN) that permits digital communications with at least one remote private network or computer facility.

5. The system of claim 4 wherein the wireless communication network comprises at least one antenna assembly having a transceiver system for transmitting and receiving signals from at least one wireless communications LAN access station.

6. The system of claim 4 wherein said at least one remote private network or computer facility comprises a network server computer communicatively coupled to said voice-responsive computing/communications device via the wireless communications network, said server computer including a database for storing application data accessible by a user of said voice-responsive computing/communications device.

7. In a voice-responsive computing/communications device having a microphone and providing speech recognition capabilities, a method for adaptively eliminating non-speech ambient background noise, comprising:
a) sampling and pulse code modulating an analog signal from the microphone;
b) transforming a pulse code modulated signal produced by (a) into a frequency domain;
c) identifying ambient non-speech noises or noise bands according to one or more predetermined digital frequency domain signatures that are characteristic of said noises or noise bands; and
d) subtracting identified ambient non-speech noises or noise bands from the pulse code modulated signal;
wherein said eliminating of non-speech ambient background noise is performed continually by said responsive computing/communications device during reception and processing of an analog signal from the microphone for providing speech recognition.

8. The method of claim 7 further comprising performing speech-specific noise elimination and speech recognition analysis on said pulse code modulated signal after subtracting identified ambient non-speech noises or noise bands.

9. The method of claim 7 further comprising performing active selective frequency band filtering of the microphone signal in the analog domain prior to sampling and transforming to a pulse code modulated signal.

10. In a voice-responsive computing/communications device having a microphone and providing speech recognition capabilities, a computer implemented method of adaptive ambient background noise elimination, comprising the steps of:
storing one or more frequency domain digital audio signatures corresponding to predetermined non-speech environmental noises or noise bands;
sampling an analog signal from the microphone and converting the analog signal to a pulse code modulated signal;
analyzing a frequency domain transform of the pulse code modulated signal to identify one or more of said frequency domain digital noise signatures; and
subtracting identified ambient non-speech noises or noise bands from the pulse code modulated signal;
wherein adaptive real-time elimination of a plurality of different ambient non-speech background noises from audio signals produced by the microphone during voice-responsive operation of the computing/communications device enhances error-free recognition of user-vocalized information and commands.

11. The method of claim 10 further comprising performing active selective frequency band filtering of the microphone signal in the analog domain prior to sampling and converting to a pulse code modulated signal.

12. The method of claim 10 further comprising performing speech-specific noise elimination and speech recognition analysis on said pulse code modulated signal after subtracting identified ambient non-speech noises or noise bands.
